(19) United States
(12) Patent Application Publication
(10) Pub. No.: US 2023/0185103 A1
(43) Pub. Date: Jun. 15, 2023

(54) SHAKE CORRECTION MECHANISM AND CAMERA MODULE EQUIPPED WITH THE SAME

(71) Applicant: Murata Manufacturing Co., Ltd., Nagaokakyo-shi (JP)

(72) Inventor: Daisuke NAKAMURA, Nagaokakyo-shi (JP)

(21) Appl. No.: 18/107,551

(22) Filed: Feb. 9, 2023

Related U.S. Application Data
(63) Continuation of application No. PCT/JP2021/022027, filed on Jun. 10, 2021.

(30) Foreign Application Priority Data
Aug. 24, 2020 (JP) 2020-141076

(51) Int. Cl. G02B 27/64; G03B 5/00

(52) U.S. Cl. CPC G02B 27/646; G03B 5/00; G03B 2205/0007; G03B 2205/0069; H02K 41/0354

(57) ABSTRACT

A camera module includes a first driver to rotate a lens module about a first axis, a second driver to rotate the lens module about a second axis, a first magnetoresistance sensor to detect the rotation of the lens module about the first axis, and a second magnetoresistance sensor to detect the rotation of the lens module about the second axis.

### CROSS REFERENCE TO RELATED APPLICATIONS

This application claims the benefit of priority to Japanese Patent Application No. 2020-141076 filed on Aug. 24, 2020 and is a Continuation application of PCT Application No. PCT/JP2021/022027 filed on Jun. 10, 2021. The entire contents of each application are hereby incorporated herein by reference.

### BACKGROUND OF THE INVENTION

### 1. Field of the Invention

The present disclosure relates to a shake correction mechanism including a movable body including optical elements, and a camera module including the shake correction mechanism.

### 2. Description of the Related Art

High performance of a smartphone requires a high-performance camera as a differentiating element. It is very common that a high-performance compact camera module (CCM) is equipped with an optical image stabilizer (OIS).

For example, US Patent Application Publication No. 2017/0295305 discloses a lens drive module equipped with an OIS function. The lens drive module described in US Patent Application Publication No. 2017/0295305 utilizes an electromagnetic drive assembly to move a lens assembly in a direction perpendicular or parallel to the optical axis. The electromagnetic drive assembly detects a change in the magnetic field generated by a magnetic member by using a Hall sensor and transmits information about the position of a lens holder relative to the bottom to a control module. Thus, the OIS described in US Patent Application Publication No. 2017/0295305 is a mechanism for translating the lens assembly in a direction perpendicular to the optical axis so as to change the imaging position of light.

### SUMMARY OF THE INVENTION

As a device for correcting a large movement or shake of a camera, there exists a correction device called a gimbal. In general, a gimbal stabilizes the imaging position by rotating the camera about a plurality of rotation axes rather than translating the camera. In recent years, a compact camera module which is installed with such a gimbal, i.e., micro-gimbal installed CCM, has appeared on the market. In the micro-gimbal installed CCM, the optical axis is corrected to an appropriate position by rotating a holder configured to hold an optical element such as a lens about a plurality of rotation axes. However, in such a camera module, there is a problem that it is required to detect the rotation angle of the holder in a wide range.

Preferred embodiments of the present invention provide shake correction mechanisms each capable of detecting a rotation angle of a movable body in a wider range when the movable body including optical elements is rotated about a plurality of rotation axes.

According to an aspect of a preferred embodiment of the present disclosure, a shake correction mechanism includes a movable body including optical elements, a housing to house the movable body, a first driver to rotate the movable body about a first axis which intersects a direction of an optical axis, a second driver to rotate the movable body about a second axis which intersects the direction of the optical axis and is perpendicular or substantially perpendicular to the first axis, a first rotation detection sensor to detect rotation of the movable body about the first axis, and a second rotation detection sensor to detect rotation of the movable body about the second axis. The first rotation detection sensor is closer to the second drive unit than the first driver. The second rotation detection sensor is closer to the first drive unit than the second driver. Each of the first rotation detection sensor and the second rotation detection sensor includes a magnetoresistive element.

According to preferred embodiments of the present disclosure, it is possible to provide shake correction mechanisms each capable of detecting a rotation angle of a movable body in a wider range when the movable body including optical elements is rotated about a plurality of rotation axes.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view illustrating a camera module according to a preferred embodiment of the present invention.

FIG. 2 is a block diagram illustrating the configuration of the camera module.

FIG. 3 is a side view of a lens module viewed from a second axial direction when the lens module is rotated about a first axis.

FIG. 4 is a side view of the lens module viewed from a first axial direction when the lens module is rotated about the first axis.

FIG. 5 is a side view of a lens module including a Hall sensor.

### DETAILED DESCRIPTION OF THE PREFERRED EMBODIMENTS

Hereinafter, preferred embodiments of the present disclosure will be described in detail with reference to the drawings. In the drawings, the same or corresponding elements or features are denoted by the same reference numerals, and the description thereof will not be repeated.

### Configuration of Camera Module 100

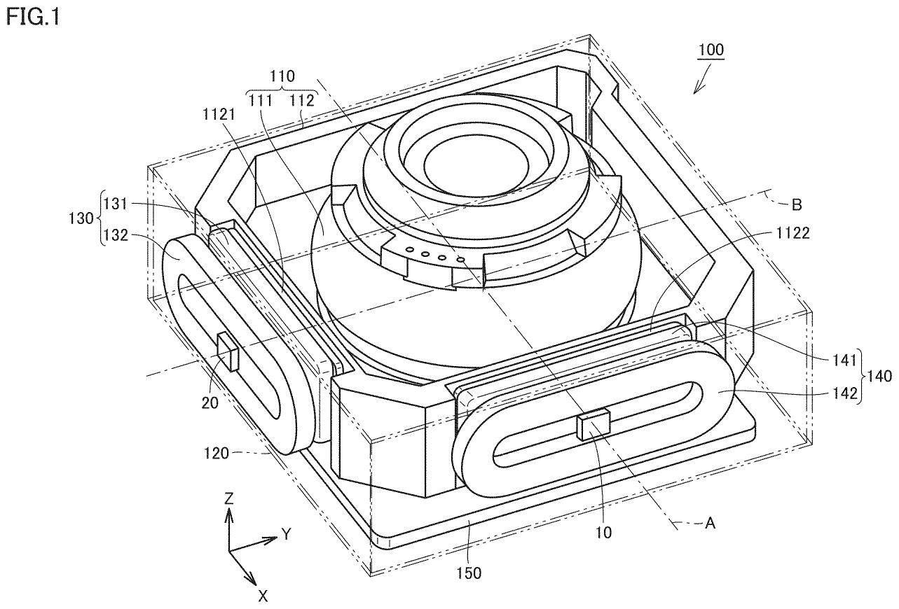

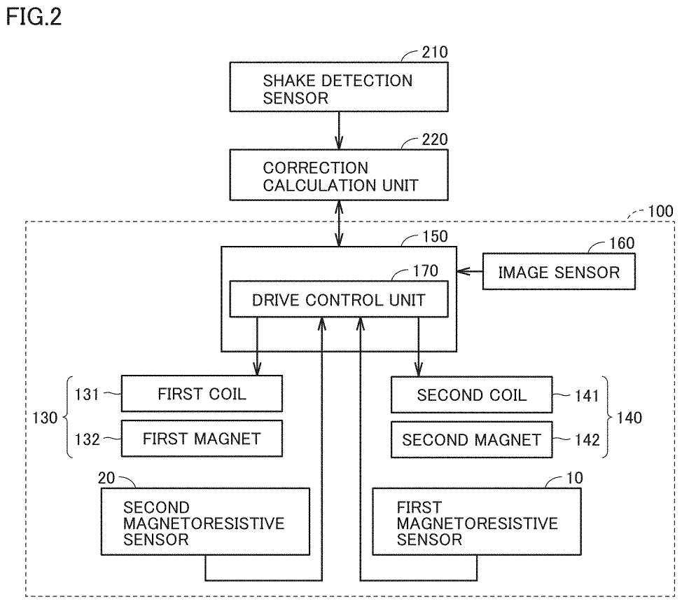

FIG. 1 is a perspective view illustrating a camera module 100 according to a preferred embodiment of the present invention. As illustrated in FIG. 1, the camera module 100 according to the present preferred embodiment includes a main substrate 150, a lens module 110 on the main substrate 150, and a base 120 that surrounds the lens module 110. Although not shown in the perspective view of FIG. 1, an image sensor 160 (see FIG. 2) is mounted on the main substrate 150. The lens module 110 is above the image sensor 160.

As illustrated in FIG. 1, a direction perpendicular to a surface of the main substrate 150 is defined as a Z-axis direction, and two directions orthogonal to the Z-axis direction are defined as an X-axis direction and a Y-axis direction, respectively. When there is no shake in the optical axis, the optical axis direction of a lens 111 is identical to the Z axis direction.

The lens module 110 is an example of a movable body including optical elements. The base 120 is an example of a housing to house the movable body. The lens module 110 includes a lens 111 to which light from the optical axis direction is incident, and a lens holder 112 that supports the lens 111. The lens 111 has a cylindrical shape, and is supported and fixed by the lens holder 112.

Two virtual lines, i.e., a first axis A and a second axis B, are depicted in FIG. 1. A virtual line that passes through the centers of the two opposing side surfaces of the lens holder 112 in the X-axis direction is denoted as the first axis A, and the other virtual line that passes through the centers of the other two opposing side surfaces of the lens holder 112 in the Y-axis direction is denoted as the second axis B. The first axis A and the second axis B are perpendicular or substantially perpendicular to each other. FIG. 1 illustrates that the first axis A and the second axis B are both perpendicular or substantially perpendicular to the optical axis.

The lens module 110 is held in place by a rotation assisting member (not shown) that allows the lens module to rotate (swing) to a certain angle about the first axis A and the second axis B. In particular, FIG. 1 illustrates a state in which the lens module 110 is parallel or substantially parallel to the surface of the main substrate 150 in the X-axis direction and the Y-axis direction.

This state is also a state in which the side surface of the lens module 110 is parallel or substantially parallel to the wall surface of the base 120 that houses the lens module 110. At this time, the first axis A is parallel or substantially parallel to the X axis, and the second axis B is parallel or substantially parallel to the Y axis. In the present preferred embodiment, the rotation angle of the lens module 110 about the first axis A and the rotation angle of the lens module 110 about the second axis B at this time are defined as 0°, respectively. According to this definition, in the lens module 110 illustrated in FIG. 1, the rotation angle about the first axis A and the rotation angle about the second axis B are both 0°.

The camera module 100 may further include a drive mechanism that drives the lens module 110 to move in the Z-axis direction so as to realize an autofocus function.

The camera module 100 further includes a first drive unit 130 (first driver) to drive the lens module 110 to rotate about the first axis A, a second drive unit 140 (second driver) to drive the lens module 110 to rotate about the second axis B, a first magnetoresistance sensor 10 to detect a rotation angle of the lens module 110 about the first axis A, and a second magnetoresistance sensor 20 to detect a rotation angle of the lens module 110 about the second axis B.

Each of the first magnetoresistive sensor 10 and the second magnetoresistive sensor 20 is an example of a rotation detection sensor, and may be an anisotropic magnetoresistive (AMR) element, for example.

Each of the first drive unit 130 and the second drive unit 140 includes a voice coil motor that includes a coil and a magnet. The first magnet 131 included in the first drive unit 130 is mounted on a holding section 1121 of the lens holder 112. The first coil 132 included in the first drive unit 130 is mounted on a side surface of the base 120 that faces the first magnet 131. In order to allow the lens module 110 to rotate about the first axis A, a certain spacing is provided between the first magnet 131 and the first coil 132.

The second magnet 141 included in the second drive unit 140 is mounted on a holding section 1122 of the lens holder 112. The second coil 142 included in the second drive unit 140 is mounted on a side surface of the base 120 that faces the second magnet 141. In order to allow the lens module 110 to rotate about the second axis B, a certain spacing is provided between the second magnet 141 and the second coil 142.

A quadrupole magnet is adopted as the first magnet 131 and the second magnet 141, for example. The first magnet 131 has a two-layer structure including a first layer opposed to the lens module 110 and a second layer opposed to the first coil 132. A lower portion of the first layer in the Z-axis direction is an S pole, and an upper portion of the first layer in the Z-axis direction is an N pole. A lower portion of the second layer in the Z-axis direction is an N pole, and an upper portion of the second layer in the Z-axis direction is an S pole. The second magnet 141 preferably has the same structure as the first magnet 131, for example.

The first magnetoresistive sensor 10 that detects the rotation angle of the lens module 110 in the direction of the first axis A is mounted on one of the four side surfaces of the base 120 on which the second coil 142 is provided. In other words, the first magnetoresistive sensor 10 is closer to the second drive unit 140 than the first drive unit 130.

For example, when the first axis A is parallel or substantially parallel to the X axis, the first magnetoresistive sensor 10 is at a position on the side surface of the base 120 which overlaps with the first axis A as viewed from the X-axis direction. In other words, the first magnetoresistive sensor 10 is at a position overlapping with the first axis A as viewed from the direction of the first axis A when the rotation angle of the lens module 110 about the second axis B is 0°. The position where the first magnetoresistive sensor 10 is located is near the center of the second coil 142 when the rotation angle of the lens module 110 about the second axis B is 0°.

The second magnetoresistive sensor 20 that detects the rotation angle of the lens module 110 in the direction of the second axis B is mounted on one of the side surfaces of the base 120 on which the first coil 132 is provided. In other words, the second magnetoresistive sensor 20 is closer to the first drive unit 130 than the second drive unit 140.

For example, when the second axis B is parallel or substantially parallel to the Y axis, the second magnetoresistive sensor 20 is at a position on the side surface of the base 120 which overlaps with the second axis B as viewed from the Y-axis direction. In other words, the second magnetoresistive sensor 20 is at a position overlapping with the second axis B as viewed from the direction of the second axis B when the rotation angle of the lens module 110 about the first axis A is 0°. The position where the second magnetoresistive sensor 20 is located is near the center of the first coil 132 when the rotation angle of the lens module 110 about the first axis A is 0°.

The rotation angle and the rotation direction of the lens module 110 are controlled by the magnitude and the direction of a current flowing through the first coil 132 and the second coil 142, respectively.

The first drive unit 130 rotates the lens module 110 to which the first magnet 131 is fixed about the first axis A by an interaction between a magnetic field generated by the current flowing through the first coil 132 and a magnetic field generated by the first magnet 131. When the rotation angle of the lens module 110 about the first axis A changes from 0° to an angle greater than 0°, the second axis B changes from a state parallel to the Y axis to a state not parallel to the Y axis.

As the lens module 110 is rotated about the first axis A, the second magnet 141 fixed to the lens module 110 is also rotated about the first axis A. For example, when the second magnet 141 is rotated by a predetermined angle, the direction of the magnetic flux density of the second magnet 141 also changes at the same angle. The first magnetoresistive sensor 10 detects the rotation angle of the lens module 110 about the first axis A by detecting the direction of the magnetic flux density.

The second drive unit 140 rotates the lens module 110 to which the second magnet 141 is fixed about the second axis B by an interaction between a magnetic field generated by the current flowing through the second coil 142 and a magnetic field generated by the second magnet 141. When the rotation angle of the lens module 110 about the second axis B changes from 0° to an angle greater than 0°, the first axis A changes from a state parallel to the X axis to a state not parallel to the X axis.

As the lens module 110 is rotated about the second axis B, the first magnet 131 fixed to the lens module 110 is also rotated about the second axis B. For example, when the first magnet 131 is rotated by a predetermined angle, the direction of the magnetic flux density of the first magnet 131 also changes at the same angle. The second magnetoresistive sensor 20 detects the rotation angle of the lens module 110 about the second axis B by detecting the direction of the magnetic flux density.

As described above, in the present preferred embodiment, when the lens module 110 is rotated by one of the pair of drive units including the first drive unit 130 and the second drive unit 140, the magnet of the other drive unit is used as a detection object to detect the rotation angle. In other words, in the present preferred embodiment, a portion of the components of the drive unit is used as a detection component to detect the rotation angle. Therefore, it is not necessary to separately provide a dedicated detection component to detect the rotation angle, which makes it possible to reduce the number of components.

### Block Diagram of Camera Module 100

FIG. 2 is a block diagram illustrating the configuration of the camera module 100. The main substrate 150 of the camera module 100 is provided with a drive control unit 170 that controls the first drive unit 130 and the second drive unit 140. The drive control unit 170 controls the magnitude and direction of a current flowing through the first coil 132 of the first drive unit 130 and the second coil 142 of the second drive unit 140, respectively. A detection value of the image sensor 160, a detection value of the first magnetoresistive sensor 10, and a detection value of the second magnetoresistive sensor 20 are input to the main substrate 150.

The drive control unit 170 controls the current flowing through the first coil 132 so as to rotate the lens module 110 about the first axis A illustrated in FIG. 1, and specifies the rotation angle of the lens module 110 about the first axis A based on the detection value of the first magnetoresistive sensor 10.

The drive control unit 170 controls the current flowing through the second coil 142 so as to rotate the lens module 110 about the second axis B illustrated in FIG. 1, and specifies the rotation angle of the lens module 110 about the second axis B based on the detection value of the second magnetoresistance sensor 20.

The camera module 100 is mounted on a camera as one of the camera components, for example. The camera including the camera module 100 is provided with a correction calculation unit 220 including an integrated circuit (IC) or the like, and a shake detection sensor 210 that detects a shake of the lens 111. The shake detection sensor 210 is connected to the correction calculation unit 220.

When a camera including the camera module 100 is used to capture a moving object as a subject, if the camera is swung up, down, left and right, a deviation occurs in the direction of the optical axis. The deviation in the direction of the optical axis is detected by the shake detection sensor 210. The shake detection sensor includes, for example, an acceleration sensor. The correction calculation unit 220 calculates a correction value to correct the deviation of the optical axis based on the detection value of the shake detection sensor 210.

This correction value is sent from the correction calculation unit 220 to the drive control unit 170 as information on the rotation angle at which the lens module 110 should be rotated about the first axis A and the second axis B illustrated in FIG. 1, respectively. The drive control unit 170 drives the first drive unit 130 and the second drive unit 140 to rotate the lens module 110 based on the correction value.

The drive control unit 170 performs a feedback control on the linear output obtained from the first magnetoresistive sensor 10 to adjust the magnitude and direction of the current flowing through the first coil 132. As a result, the lens module 110 is rotated about the first axis A, and the deviation in the optical axis direction is corrected. The drive control unit 170 performs a feedback control on the linear output obtained from the second magnetoresistive sensor 20 to adjust the magnitude and direction of the current flowing through the second coil 142. As a result, the lens module 110 is rotated about the second axis B, and the deviation in the optical axis direction is corrected.

Thus, the drive control unit 170 controls the rotation angle of the lens module 110 using the detection value of the first magnetoresistive sensor 10 or the second magnetoresistive sensor 20 to achieve a target correction value. As a result, the drive control unit 170 can smoothly and quickly correct the optical axis. As described above, according to the present preferred embodiment, by rotating the lens module 110 when the light incident on the lens 111 is focused on the image sensor 160, it is possible for the light to stably enter the image sensor 160 even under a camera shake.

### Mechanism for Detecting Rotation of Lens Module 110

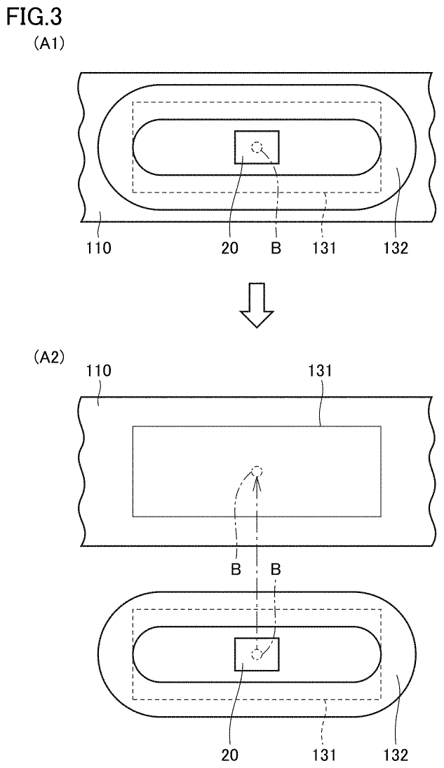

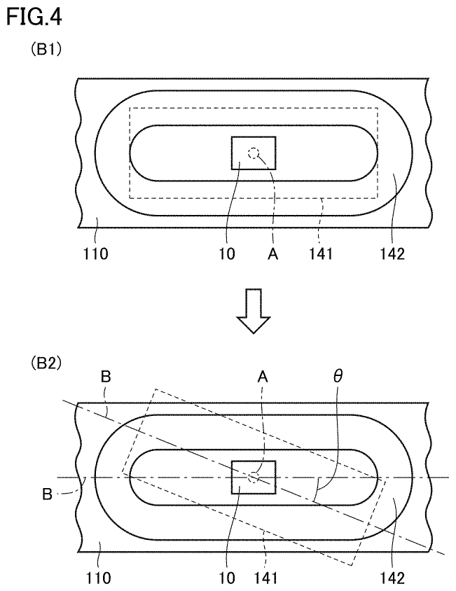

FIG. 3 is a side view of the lens module 110 viewed from the direction of the second axis B when the lens module 110 is rotated about the first axis A. FIG. 4 is a side view of the lens module 110 viewed from the first axis A direction when the lens module 110 is rotated about the first axis A. In FIGS. 3 and 4, the lens 111 and the base 120 are not shown.

Part (A1) of FIG. 3 and part (B1) of FIG. 4 are side views of the lens module 110 when the rotation angle of the lens module 110 about the first axis A is 0°. Part (A1) of FIG. 3 and part (B1) of FIG. 4 illustrate the same state of the lens module 110 as viewed from the direction of the second axis B and the direction of the first axis A, respectively.

For the purpose of simplifying the description of FIGS. 3 and 4, it is assumed that the rotation angle of the lens module 110 about the second axis B is maintained at 0°. As described above with reference to FIG. 1, when the first axis A is parallel to the X axis and the second axis B is parallel to the Y axis, the rotation angle of the lens module 110 about the first axis A and the rotation angle of the lens module 110 about the second axis B are both 0°.

Hereinafter, a method of detecting a rotation angle of the lens module 110 using the first magnetoresistive sensor 10 when the lens module 110 is rotated about the first axis A will be described with reference to FIGS. 3 and 4.

As illustrated in part (A1) of FIG. 3, when the rotation angle of the lens module 110 about the first axis A is 0°, the side surface of the lens module 110 to which the first magnet 131 is fixed, the first coil 132, and the second magnetoresistive sensor 20 overlap with each other and line up around the second axis B. The first coil 132 and the second magnetoresistive sensor 20 are fixed to the base 120 (not shown).

When the lens module 110 is viewed from the direction of the first axis A at this time, as illustrated in part (B1) of FIG. 4, the side surface of the lens module 110 to which the second magnet 141 is fixed, the second coil 142, and the first magnetoresistive sensor 10 overlap with each other and line up around the first axis A. The second coil 142 and the first magnetoresistive sensor 10 are fixed to the base 120 (not shown).

Part (A2) of FIG. 3 and part (B2) of FIG. 4 illustrate the lens module 110 which is rotated about the first axis A from the state illustrated in part (A1) of FIG. 3 and part (B1) of FIG. 4, respectively. Part (A2) of FIG. 3 and part (B2) of FIG. 4 illustrate the same state of the lens module 110 as viewed from the direction of the second axis B and the direction of the first axis A, respectively.

As illustrated in part (A2) of FIG. 3, when the lens module 110 is rotated about the first axis A, the second axis B passing through the side surface of the lens module 110 is moved from the original position together with the side surface of the lens module 110 to which the first magnet 131 is fixed. As a result, the second axis B is moved away from the position of the first coil 132 and the position of the second magnetoresistive sensor 20.

The state of the lens module 110 at this time as viewed from the direction of the first axis A is illustrated in part (B2) of FIG. 4. In other words, the side surface of the lens module 110 is rotated about the first axis A together with the second magnet 141, and is inclined by a rotation angle θ. Accordingly, the direction of the magnetic flux density of the second magnet 141 changes by the rotation angle θ. The first magnetoresistive sensor 10 detects the rotation angle θ by detecting the direction of the magnetic flux density of the second magnet 141.

When the lens module 110 is rotated about the first axis A, the inclination angle of the second magnet 141 relative to the first magnetoresistive sensor 10 is equal to the rotation angle of the first axis A. It should be noted that the first magnetoresistive sensor 10 can directly detect a change in the direction of the magnetic flux density of the second magnet 141 as the rotation angle. In other words, the first magnetoresistive sensor 10 defines and functions as a rotation detection sensor that directly detects the rotation of the lens module 110.

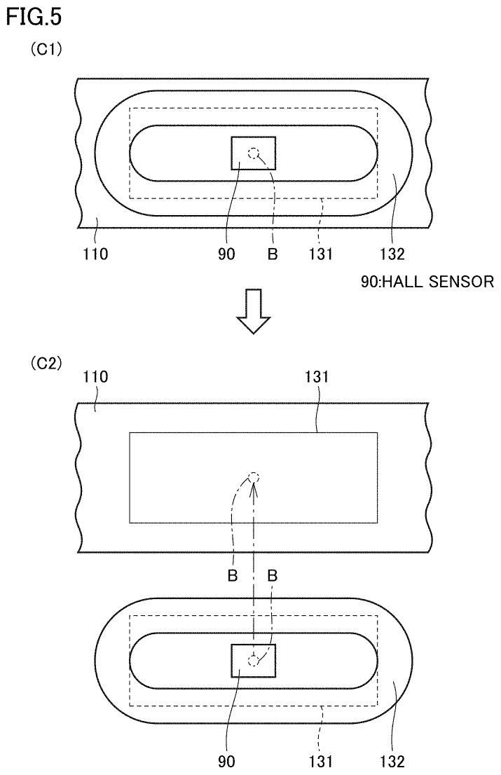

According to the present preferred embodiment, it is possible to simplify the procedure of detecting the rotation angle of the lens module 110 as compared with a configuration in which the rotation of the lens module 110 is detected based on a change in the distance between a sensor and a detection object disposed in the lens module 110, which will be described later in detail with reference to FIG. 5.

It should also be noted that when the lens module 110 is rotated about the first axis A, the distance between the second magnet 141 and the first magnetoresistive sensor 10 does not change. When the lens module 110 is inclined not only about the first axis A but also about the second axis B, the distance between the second magnet 141 and the first magnetoresistive sensor 10 will increase as the rotation angle of the second axis B increases.

However, the rotation of the lens module 110 about the first axis A itself does not move the magnet to be detected by the first magnetoresistive sensor 10 away from the first magnetoresistive sensor 10. According to the present preferred embodiment, it is possible to stably detect the rotation angle of the lens module 110 regardless of the size of the rotation angle of the lens module 110. As a result, according to the present preferred embodiment, it is possible to provide a shake correction mechanism capable of detecting the rotation angle of the lens module 110 in a wider range.

With reference to FIGS. 3 and 4, the method by which the first magnetoresistive sensor 10 detects the angle of rotation of the lens module 110 when the lens module 110 is rotated about the first axis A has been described. When the lens module 110 is rotated about the second axis B, although the target rotation axis is different, the second magnetoresistive sensor 20 can detect the rotation angle of the lens module 110 about the second axis by the same method. The description thereof will not be repeated.

Comparative Example in which a Hall Sensor is Adopted

FIG. 5 is a side view of the lens module 110 which is including a Hall sensor 90 instead of the magnetoresistive sensor in FIG. 3. The present preferred embodiment is characterized in that a magnetoresistive sensor is used as a rotation detection sensor to detect the rotation angle of the lens module 110. In order to further understand the function and effect of the present preferred embodiment, a configuration in which a Hall sensor is used instead of a magnetoresistive sensor will be described as a comparative example to the present preferred embodiment.

Part (C1) of FIG. 5 corresponds to part (A1) of FIG. 3, and is a side view of the lens module 110 when the rotation angle of the lens module 110 about the first axis A is 0°. Part (C2) of FIG. 5 corresponds to part (A2) of FIG. 3, and is a side view of the lens module 110 when the lens module 110 is rotated by a predetermined angle about the first axis A.

However, in the comparative example of FIG. 5, the Hall sensor 90 is used as a magnetic sensor instead of a magnetoresistive sensor. The Hall sensor 90 is configured to detect the intensity of the magnetic flux density of a magnet which serves as a detection target. In this respect, the Hall sensor 90 is fundamentally different from the magnetoresistive sensor that detects the direction of the magnetic flux density.

When the Hall sensor 90 is adopted, it is necessary to specify the rotation angle of the lens module 110 about the first axis A based on a change in the distance between the Hall sensor 90 and the first magnet 131, in other words, a change in the intensity of the magnetic flux density of the first magnet 131 to be detected by the Hall sensor 90.

If the Hall sensor 90 is disposed at the position of the first magnetoresistive sensor 10 as illustrated in part (A2) of FIG. 3 and part (B2) of FIG. 4, the distance between the second magnet 141 and the Hall sensor 90 does not change as the lens module 110 is rotated. Therefore, when the Hall sensor 90 is adopted, the rotation of the lens module 110 cannot be directly detected.

Therefore, when the Hall sensor 90 is adopted, it is necessary to indirectly calculate the rotation angle of the lens module 110 from the change in the intensity of the magnetic flux density to be detected by the Hall sensor 90. On the other hand, in the present preferred embodiment, since the rotation of the lens module 110 is directly detected by the first magnetoresistive sensor 10, the procedure to detect the rotation angle of the lens module 110 can be simplified.

As apparently seen from FIG. 5, the distance between the Hall sensor 90 and the first magnet 131 increases as the rotation angle of the lens module 110 about the first axis A increases. As the distance between the Hall sensor 90 and the first magnet 131 increases, the intensity of the magnetic flux density of the first magnet 131 to be detected by the Hall sensor 90 decreases and becomes unstable.

When the rotation angle of the lens module 110 about the first axis A exceeds a certain limit angle, depending on the performance of the Hall sensor 90 and the first magnet 131, the Hall sensor 90 may not accurately detect the intensity of the magnetic flux density of the first magnet 131. On the other hand, in the present preferred embodiment, even when the lens module 110 is rotated about the first axis A, the magnet to be detected by the first magnetoresistive sensor 10 does not move away from the first magnetoresistive sensor 10.

Therefore, according to the present preferred embodiment, it is possible to stably detect the rotation angle of the lens module 110 regardless of the size of the rotation angle of the lens module 110. As a result, according to the present preferred embodiment, it is possible to provide a shake correction mechanism capable of detecting the rotation angle of the lens module 110 in a wider range.

### Modified Example

Hereinafter, a modified example of the present preferred embodiment described above and features thereof will be further described.

The camera module 100 includes a shake correction mechanism. The shake correction mechanism includes a lens module 110, a base 120, a first drive unit 130 (first driver), a second drive unit 140 (second driver), a first magnetoresistive sensor 10, and a second magnetoresistive sensor 20.

The first drive unit 130 and the second drive unit 140 are not limited to including a voice coil motor. The first drive unit 130 and the second drive unit 140 may include a piezoelectric motor, an ultrasonic motor, or a shape memory alloy motor. In this case, a first magnet to be detected by the first magnetoresistive sensor 10 and a second magnet to be detected by the second magnetoresistive sensor 20 may be fixed to the lens module 110.

Each of the first magnetoresistive sensor 10 and the second magnetoresistive sensor 20 is merely an example of a rotation detection sensor. Each of the first magnetoresistive sensor 10 and the second magnetoresistive sensor 20 may be, for example, an anisotropic magnetoresistive (AMR) sensor. However, the rotation detection sensor is not limited thereto, and it may be any of the other kinds of magnetoresistive sensors.

For example, a giant magnetoresistance (GMR) element or a tunnel magnetoresistance (TMR) element may be used as a magnetoresistance sensor. Alternatively, each of the first magnetoresistive sensor 10 and the second magnetoresistive sensor 20 may include a combination of these magnetoresistance elements.

As illustrated in FIG. 1, when the rotation angle of the lens module 110 about the second axis B is 0°, the first magnetoresistive sensor 10 is located at the center of the first axis A as viewed from the direction of the first axis A. By providing the first magnetoresistance sensor 10 at the center of the first axis A, it is possible to make the rotation angle of the lens module 110 about the first axis A equal to the rotation angle of the magnetic field of the second magnet 141 detected by the first magnetoresistance sensor 10.

Since the size of the first magnetoresistive sensor 10 is considerably smaller than the size of the second magnet 141, a region for positioning the first magnetoresistive sensor 10 so as to overlap with the second magnet 141 as viewed from the direction of the first axis A is greater. No matter where the first magnetoresistive sensor 10 is positioned in the region, the rotation angle of the lens module 110 about the first axis A may be equal or substantially equal to the rotation angle of the magnetic field of the second magnet 141 detected by the first magnetoresistive sensor 10.

Therefore, when the rotation angle of the lens module 110 about the second axis B is 0°, the location of the first magnetoresistive sensor 10 may be shifted from the center of the first axis A as viewed from the direction of the first axis A. When the rotation angle of the lens module 110 about the second axis B is 0°, the first magnetoresistive sensor 10 may be located at any position in the region where the second magnet 141 and the first magnetoresistive sensor 10 overlap with each other as viewed from the direction of the first axis A.

The same also applies to the second magnetoresistive sensor 20. In other words, when the rotation angle of the lens module 110 about the first axis A is 0°, the second magnetoresistive sensor 20 may be located at any position in the region where the first magnet 131 and the second magnetoresistive sensor 20 overlap with each other as viewed from the direction of the second axis B.

As described above, the mounting position of the first magnetoresistive sensor 10 may be in the vicinity of the first axis A or in the vicinity of the second coil 142 as viewed from the direction of the first axis A when the rotation angle of the lens module 110 about the second axis B is 0°. Similarly, the mounting position of the second magnetoresistance sensor 20 may be in the vicinity of the second axis B or in the vicinity of the first coil 132 as viewed from the direction of the second axis B when the rotation angle of the lens module 110 about the first axis A is 0°. Thus, the first magnetoresistive sensor 10 may be located in the vicinity of the second drive unit 140. The second magnetoresistive sensor 20 may be located in the vicinity of the first drive unit 130.

The statement of “when the rotation angle of the lens module 110 about the first axis A is 0°” is an example statement of “when the movable body is not rotated about the first axis”. The statement of “when the rotation angle of the lens module 110 about the second axis B is 0°” is an example statement of “when the movable body is not rotated about the second axis”. The statement of “at any position in the region where the second magnet 141 and the first magnetoresistive sensor 10 overlap with each other as viewed from the direction of the first axis A” is an example statement of “at or around a position overlapping with the first axis A as viewed from the direction of the first axis A”. The statement of “at any position in the region where the first magnet 131 and the second magnetoresistive sensor 20 overlap with each other as viewed from the direction of the second axis B” is an example statement of “at or around a position overlapping with the second axis B as viewed from the direction of the second axis B”.

Thus, when the first magnetoresistance sensor 10 is slightly shifted from the first axis A and the second magnetoresistance sensor 20 is slightly shifted from the second axis B, even if the lens module 110 is rotated about both the first axis A and the second axis B, it is possible to maintain linearity so as to stably detect the rotation angle of the lens module 110.

On the other hand, when the Hall sensor 90 is adopted instead of the magnetoresistive sensor, the restriction on the position of the sensor is greater than that in the present preferred embodiment. For example, with reference to FIG. 5, when the lens module 110 is rotated not only about the first axis A but also about the second axis B, the first magnet 131 illustrated in FIG. 5 is rotated and is inclined. When the Hall sensor 90 is displaced from the position illustrated in FIG. 5, the intensity of the magnetic flux density detected by the Hall sensor 90 is strongly influenced by the position of the Hall sensor 90 and the inclination of the first magnet 131.

Therefore, when the Hall sensor 90 is adopted, the restriction on the position of the sensor is greater than that in the present preferred embodiment in which the first magnetoresistive sensor 10 and the second magnetoresistive sensor 20 are adopted. In other words, the configuration according to the present preferred embodiment allows a higher degree of freedom to dispose the rotation detection sensor as compared with the configuration in which the Hall sensor 90 is adopted.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A shake correction mechanism comprising:
a movable body in which optical elements are provided;
a housing to house the movable body;
a first driver to rotate the movable body about a first axis which intersects a direction of an optical axis;
a second driver to rotate the movable body about a second axis which intersects the direction of the optical axis and is perpendicular or substantially perpendicular to the first axis;
a first rotation detection sensor to detect rotation of the movable body about the first axis; and
a second rotation detection sensor to detect rotation of the movable body about the second axis;
the first rotation detection sensor being closer to the second driver than the first driver;
the second rotation detection sensor being closer to the first driver than the second driver; and
each of the first rotation detection sensor and the second rotation detection sensor including a magnetoresistive element.

2. The shake correction mechanism according to claim 1, wherein
each of the first driver and the second driver includes a voice coil motor including a magnet and a coil;
the magnet is in the movable body; and
the coil is in the housing.

3. The shake correction mechanism according to claim 2, wherein
the first rotation detection sensor is operable to detect the rotation of the movable body about the first axis by detecting a direction of a magnetic flux density of the magnet included in the first driver; and
the second rotation detection sensor is operable to detect the rotation of the movable body about the second axis by detecting a direction of a magnetic flux density of the magnet included in the second driver.

4. The shake correction mechanism according to claim 1, wherein
the first rotation detection sensor is at a first position overlapping the first axis or around the first position when the movable body is not rotated about the second axis as viewed from the direction of the first axis; and
the second rotation detection sensor is at a second position overlapping the second axis or around the second position when the movable body is not rotated about the first axis as viewed from a direction of the second axis.

5. The shake correction mechanism according to claim 1, wherein the magnetoresistive element is an anisotropic magnetoresistive element.

6. The shake correction mechanism according to claim 1, wherein the magnetoresistance element is a giant magnetoresistance element.

7. The shake correction mechanism according to claim 1, wherein the magnetoresistance element is a tunnel magnetoresistance element.

8. The shake correction mechanism according to claim 1, wherein each of the first driver and the second driver includes a voice coil motor including a coil and a magnet spaced from each other.

9. The shake correction mechanism according to claim 8, wherein the magnet is a quadrupole magnet.

10. The shake correction mechanism according to claim 8, wherein the magnet includes a first layer and a second layer.

11. A camera module including the shake correction mechanism according to claim 1.

12. The camera module according to claim 11, wherein
each of the first driver and the second driver includes a voice coil motor including a magnet and a coil;
the magnet is in the movable body; and
the coil is in the housing.

13. The camera module according to claim 12, wherein
the first rotation detection sensor is operable to detect the rotation of the movable body about the first axis by detecting a direction of a magnetic flux density of the magnet included in the first driver; and
the second rotation detection sensor is operable to detect the rotation of the movable body about the second axis by detecting a direction of a magnetic flux density of the magnet included in the second driver.

14. The camera module according to claim 11, wherein
the first rotation detection sensor is at a first position overlapping the first axis or around the first position when the movable body is not rotated about the second axis as viewed from the direction of the first axis; and
the second rotation detection sensor is at a second position overlapping the second axis or around the second position when the movable body is not rotated about the first axis as viewed from a direction of the second axis.

15. The camera module according to claim 11, wherein the magnetoresistive element is an anisotropic magnetoresistive element.

16. The camera module according to claim 11, wherein the magnetoresistance element is a giant magnetoresistance element.

17. The camera module according to claim 11, wherein the magnetoresistance element is a tunnel magnetoresistance element.

18. The camera module according to claim 11, wherein each of the first driver and the second driver includes a voice coil motor including a coil and a magnet spaced from each other.

19. The camera module according to claim 18, wherein the magnet is a quadrupole magnet.

20. The camera module according to claim 18, wherein the magnet includes a first layer and a second layer.
